(19) United States
(12) Patent Application Publication
(10) Pub. No.: US 2010/0007712 A1
(43) Pub. Date: Jan. 14, 2010

(54) VIDEO COMMUNICATION APPARATUS AND METHOD FOR DUAL STANDBY MOBILE TERMINAL

(75) Inventor: Ki Tae JANG, Seongnam-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/500,937

(22) Filed: Jul. 10, 2009

(30) Foreign Application Priority Data
Jul. 11, 2008 (KR) 10-2008-0067462

(51) Int. Cl. H04N 7/14

(52) U.S. Cl. 348/14.02; 348/E07.078

(57) ABSTRACT

A video communication apparatus and method for a multi-standby mobile terminal is provided for accomplishing video communication using two communication modules supporting two different communication systems. The video communication apparatus for the multi-standby mobile terminal includes a first communication module which establishes a voice channel with a counterpart mobile terminal for exchanging voice signals via a first communication network and a second communication module which establishes a video channel with the counterpart mobile terminal for exchanging video signals via a second communication network.

### CROSS REFERENCE TO RELATED APPLICATION

This application claims priority from and the benefit of Korean Patent Application No. 10-2008-0067462, filed on Jul. 11, 2008, which is hereby incorporated by reference for all purposes as if fully set forth herein.

### BACKGROUND OF THE INVENTION

1. Field of the Invention

Exemplary embodiments of the present invention relate generally to a multi-standby mobile terminal and, in particular, to a video communication apparatus and method for a multi-standby mobile terminal to accomplish video communication using two communication modules supporting two different communication systems.

2. Description of the Background

Mobile terminals are quickly advancing and now include several feature-rich functions including multi-mode communication capabilities that support more than two radio interfaces. Unlike conventional single mode mobile terminals dedicated for networks of a specific communication service provider, a multi-mode mobile terminal (e.g., a dual mode mobile terminal supporting Code Divisional Multiple Access (CDMA) and Global System for Mobile Communications (GSM)) may allow subscribers to roam between networks of different communication service providers and hence provide greater service coverage. However, in a conventional dual mode mobile terminal, the mode selection is done in idle mode after a boot-up process with laborious steps resulting in a waste of time. There is also a need to improve utilization of current dual standby mobile terminals.

### SUMMARY OF THE INVENTION

Exemplary embodiments of the present invention provide a video communication apparatus and method for a multi-standby mobile terminal to improve a quality of video communication by communicating audio signals through one communication module and video signals through another communication module.

Additional features of the invention will be set forth in the description which follows, and in part will be apparent from the description, or may be learned by practice of the invention.

Exemplary embodiments of the present invention provide a video communication apparatus for a first multi-standby mobile terminal comprising a first communication module and a second communication module. The first communication module establishes a voice channel with a counterpart second mobile terminal to exchange voice signals via a first communication network. The second communication module establishes a video channel with the second mobile terminal to exchange video signals via a second communication network.

Exemplary embodiments of the present invention provide a video communication method for a first multi-standby mobile terminal having at least two communication modules supporting different communication systems. The method comprises establishing two communication channels with a counterpart second mobile terminal using the at least one communication modules. The method further comprises transmitting voice signals through a first communication channel and video signals through a second communication channel.

Exemplary embodiments of the present invention provide a video communication method for a first multi-standby mobile terminal having at least two communication modules supporting different communication systems. The method comprises establishing a voice call connection, using a first communication module of the at least two communication modules, with a corresponding first communication module of a counterpart second mobile terminal. The method also comprises exchanging, with the second mobile terminal, messages containing identity information and connection information, and establishing a video call connection, using a second communication module of the at least two communication modules, with a corresponding second communication module of the second mobile terminal. The method further comprises communicating voice signals through the voice call connection and video signals through the video call connection with the second mobile terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the exemplary embodiments of the invention and are incorporated in and constitute a part of this specification, illustrate exemplary embodiments of the invention, and together with the description serve to explain the principles of the invention.

FIG. 1 illustrates a call processing method of a dual standby mobile terminal according to exemplary embodiments of the present invention.

FIG. 2 is a block diagram illustrating a configuration of a mobile terminal according to exemplary embodiments of the preset invention.

FIG. 3A is a message flow diagram illustrating a procedure for acquiring information for video communication according to exemplary embodiments of the present invention.

FIG. 3B is a diagram illustrating a format of the request message transmitted at step S301 of FIG. 3A.

FIG. 3C is a screen image displayed on the mobile terminal according to exemplary embodiments of the present invention.

FIG. 4 is a message flow diagram illustrating a video communication method according to exemplary embodiments of the present invention.

FIG. 5 is a message flow diagram illustrating a video communication method according to exemplary embodiments of the present invention.

### DETAILED DESCRIPTION OF ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Detailed descriptions of well-known functions and structures incorporated herein may be omitted to avoid obscuring the subject matter of the present invention.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, or section from another element, component, region, or section. Thus, a first element, component, region, or section discussed below could be termed a second element, component, region, or section without departing from the teachings of the present invention.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, the video communication apparatus and method of the present invention is described with reference to a dual standby mobile terminal as a type of the multi-mode mobile terminal.

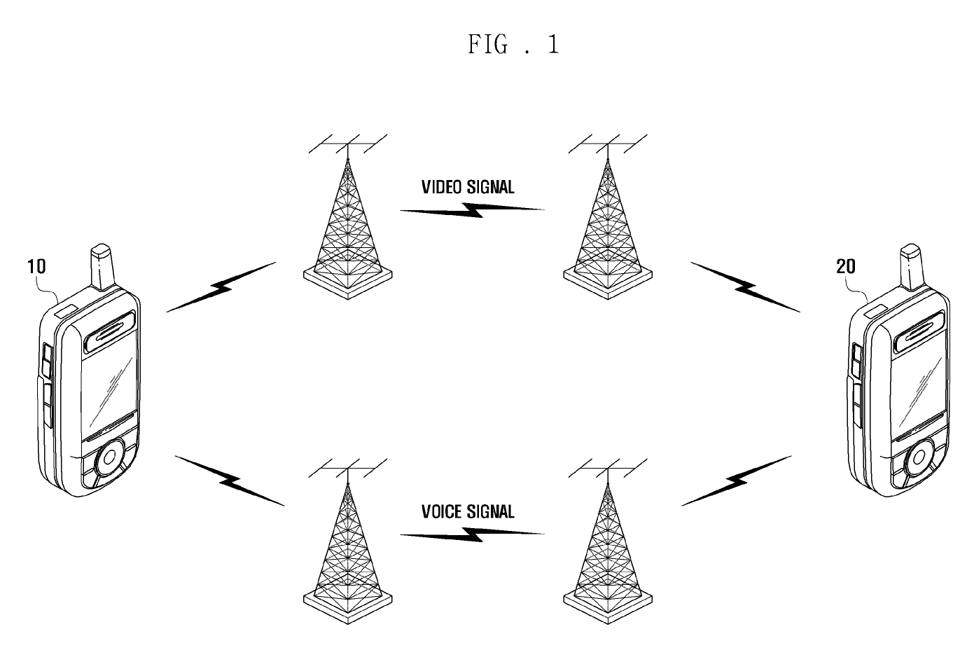

The call processing procedure of a dual standby mobile terminal is first described. FIG. 1 illustrates a call processing method of a dual standby mobile terminal according to exemplary embodiments of the present invention.

A dual standby mobile terminal may be provided with two communication modules that may operate with different radio interfaces and may process voice calls independently. In FIG. 1, the first mobile terminal 10 may be a sending mobile terminal and the second mobile terminal may be a recipient mobile terminal 20. In other cases, the first mobile terminal 10 may be a recipient mobile terminal and the second mobile terminal may be a sending mobile terminal 20.

Referring to FIG. 1, the first mobile terminal 10 may establish a primary call connection using one of two communication modules, and a secondary call connection using the other communication module, with second mobile terminal 20. The primary and secondary call connections can be established through different call establishment procedures according to respective communication service providers.

After the primary and secondary call connections are established, the first and second mobile terminals 10 and 20 may communicate voice signals through a primary communication channel established using one of the communication modules and video signals through a secondary communication channel established using the other communication module. For example, the video signal may be transmitted through the secondary voice call channel. The video signal may be transmitted in the quality supported by the secondary voice call channel. The first and second mobile terminals 10 and 20 may be configured to play the video signal received from the other mobile terminal in synchronization with the corresponding voice signal. Accordingly, the mobile terminals may establish two voice communication channels using two communication modules to establish a video call session. The mobile terminals may be multimode mobile terminals and particularly multi-standby mobile terminals.

A dual standby mobile terminal for achieving the aforementioned video communication is described hereinafter.

The structure of the dual standby mobile terminal (hereinafter referred to as mobile terminal) according to exemplary embodiments of the present invention is described hereinafter.

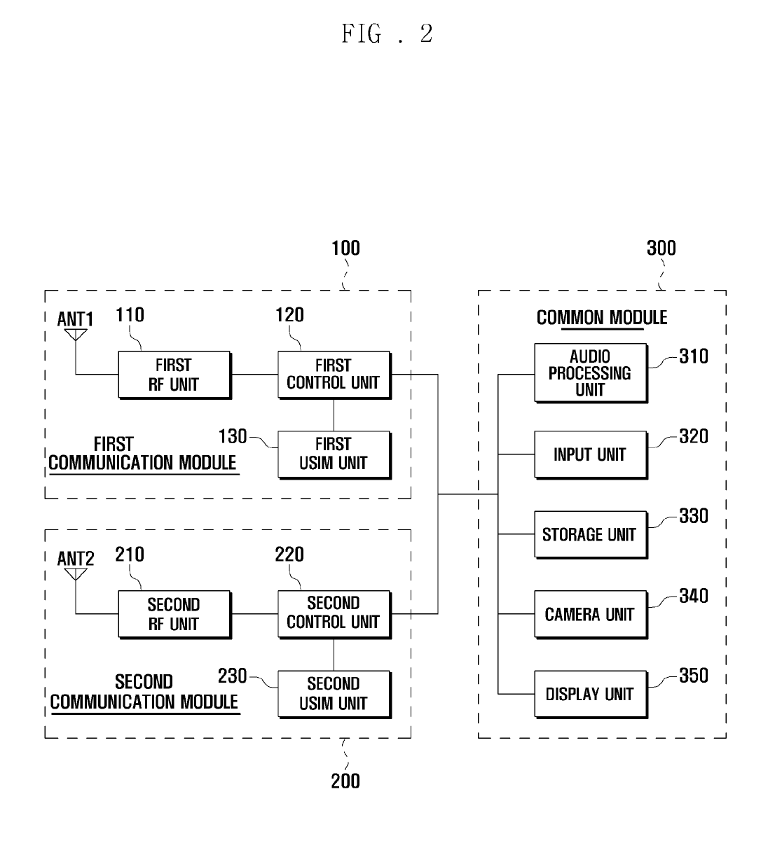

FIG. 2 is a block diagram illustrating a configuration of a mobile terminal according to exemplary embodiments of the preset invention.

The mobile terminal can be implemented with two communication modules that support either homogeneous or heterogeneous communication systems. The first and second communication modules 100 and 200 may support, at least, either GSM or CDMA. For instance, the first communication module can be a GSM module or a CDMA module, and the second communication module may also be a GSM module or a CDMA module. In general, the communication modules may support various types of communication systems having various radio communication protocols.

The mode switching of the mobile terminal can be performed according to a configuration of smart cards, (e.g., Subscriber Identity Module (SIM) card and/or Universal SIM card). Each smart card may be inserted in the mobile terminal and may be configured to support different communication systems. When a valid smart card (SIM or USIM) is connected to a communication module, the mobile terminal can access the service of the corresponding service provider by means of the smart card. If the first communication module supports GSM and CDMA and the second communication module supports CDMA, the mobile terminal can stand by in GSM and CDMA modes or in two different CDMA modes depending on the configuration of smart cards attached to the first and second communication modules.

Referring to FIG. 2, the mobile terminal, operating as a multi-standby mobile terminal, may include a first communication module 100 supporting a radio communication systems and a second communication module 200 supporting another radio communication system. The first communication module 100 may include a first Radio Frequency (RF) unit 110, a first control unit 120, and a first USIM unit 130; and the second communication module 200 may include a second RF unit 210, a second control unit 220, and a second USIM unit 230. The mobile terminal may also include a common module 300, which may be directly connected to at least one of the first and second communication modules 100 and 200. The common module 300 may include an audio processing unit 310, an input unit 320, a storage unit 330, a camera unit 340, and a display unit 350.

The first and second RF units 110 and 210 may support radio communications with other mobile terminals for data, voice, and/or video communications. The first and second RF units 110 and 210 may include a transmit (Tx) end for up-converting and amplifying a signal output by a corresponding control unit 120 and 220, and a receive (Rx) end for low noise amplifying and down-converting a received radio signal. The Tx and Rx ends can be configured differently depending on the communication protocols for use in the communication system.

The first and second RF units 110 and 120 may be coupled to respective first and second antennas ANT1 and ANT2. The first and second antennas ANT1 and ANT2 may be configured to transmit and receive radio signals over corresponding frequencies. In general, the first and second antennas ANT1 and ANT2 may operate over a broad range of frequencies (e.g., kilohertz, megahertz, and gigahertz), and are not limited to frequencies associated with radio waves.

The first and second control units 120 and 220 may control data, voice, and video signals that are output to the corresponding first and second RF units 110 and 210. Also, the first and second control units 120 and 220 may receive the data, voice, and audio signals output by the first and second RF units 110 and 210.

The first and second control units 120 and 220 may encode, interleave, and/or modulate voice signals input by the audio processing unit 310, and may then output the processed signals to the corresponding first and second RF units 110 and 210. The first and second control units 120 and 220 may also demodulate, equalize, decode, and deinterleave voice signals provided by the corresponding first and second RF units 110 and 210, and may then output the processed signals to the audio processing unit 310.

The first and second control units 120 and 220 may include a modem and a codec. The codec may include a data codec for processing packet data, an audio codec for processing audio signals including voice, and a video codec for processing video signals.

The first and second control units 120 and 220 may control signaling for establishing call connections. For example, the first and second control units 120 and 220 may control transmission of a call connection request message through a radio channel of the corresponding communication system to establish a channel. The first and second control units 120 and 220 may, for example, transmit a call connection request message to a counterpart mobile terminal by means of the corresponding RF units 110 and 210. The first and second control units 120 and 220 can identify the counterpart mobile terminal with identity information of the counterpart mobile terminal and may distinguish the communication modules of the counterpart mobile with connection information.

If two or more call connection request messages are received from a single counterpart mobile terminal, the first and second control units 120 and 220 may identify the counterpart mobile terminal by comparing the identity information contained in the connection request messages and may distinguish the communication modules of the counterpart mobile terminal with reference to the connection information contained in the call connection request message. Accordingly, when two or more call connection request messages are received from the same counterpart mobile terminal, the mobile terminal may determine that the counterpart mobile terminal requests a video call.

When the call connection is established, one of the first and second control units 120 and 220 may control, using its corresponding RF unit 110 or 220, transmission of a voice signal input through an audio input device, such as, for example, a microphone. A voice signal received by means of the RF unit may be output through an audio output device, such as, for example, a speaker. The other control unit may control, using its corresponding RF unit 110 or 220, transmission of a video signal input through a video input device, such as, for example, camera unit 340. The video signal may be output on the display unit 350. The control units 120 and 220 may also control processing and outputting of the audio and video signals received through corresponding RF units 110 and 210.

The first and second control units 120 and 220 may generate and control transmission of call requests and response messages to a counterpart mobile terminal. The call request and response messages can be stored in the storage unit 330, a first USIM unit 130, and/or a second USIM unit 230.

The first and second USIM units 130 and 230 can be selectively operated such that, when a communication module is configured to operate with a USIM, a corresponding USIM unit is activated. The first and second USIM units 130 and 230 can be implemented with an Integrated Circuit Card (ICC) function that may incorporate a storage device and a processor. The storage device can be a Random Access Memory (RAM) and/or a Read Only Memory (ROM), and the processor can be a Central Process Unit (CPU). In general, any suitable processor and storage device may be used. The first and second USIM units 130 and 230 can be provided in the form of a fixed or detachable Universal ICC (UICC).

In case that the first control unit 120 supports both CDMA and GSM and the second control unit 220 supports GSM, the mobile terminal can be configured to operate in a dual standby mode (i.e. GSM-GSM standby mode) by inserting the two GSM USIMs into the respective first and second USIM units 130 and 230. The mobile terminal also can be configured to operate in a dual CDMA-GSM standby mode by inserting a CDMA USIM into the first USIM unit 130 and a GSM USIM into the second USIM unit 230.

The USIM units 130 and 230 or a USIM inserted thereto may store a subscriber identity (ID). The subscriber ID may be used when the mobile terminal attempts to access a network of the corresponding service provider, for authentication, ciphering, and tunneling with ciphering purposes. The first and second USIM units 130 and 230 may also store connection information in association with its ID and the counterpart mobile terminal ID.

As noted above, the common module 300 may include the audio processing unit 310, input unit 320, storage unit 330, camera unit 340, and display unit 350.

The audio processing unit 310 may include an audio output device (e.g., a speaker) and an audio input device (e.g., a microphone). An audio signal may be input from the audio input device, processed using the first or second control units 120 or 220, and subsequently output through the audio output device.

The input unit 320 may include a plurality of alphanumeric keys for inputting alphanumeric data and function keys to set and execute various functions of the mobile terminal. The function keys may include navigation keys, side keys, and shortcut keys. The input unit 320 may transfer a key sequence generated by a key input to the first and second control units 120 and 220. The input unit 320 may also provide a video call key. The video call key may be a special key for enabling the first and second communication unit 100 and 200 to process the call connection request or the call connection response simultaneously.

The storage unit 330 may store application programs associated with the functions of the mobile terminal, downloaded contents, and user data. The storage unit 330 can be divided into a program region and a data region. The program region may store an Operating System (OS) for booting up the mobile terminal and application programs for executing supplementary optional functions. The data region may store the application and user data. The storage unit 330 can also store device ID information of the mobile terminal and connection information associated with the first and second communication modules 100 and 200. The connection information may also be stored along with the device ID information in the respective first and second SIM/USIM units 130 and 230.

The camera unit 340 may be provided in the mobile terminal to acquire video data. The camera unit 340 may include a pickup device (not shown), a signal processing device (not shown), and a video processing device (not shown). The pickup device may be a camera sensor for capturing an optical image and converting optical image into an electrical signal. In some cases, the camera sensor can be a Charge Coupled Device (CCD). The signal processing device may convert an analog signal output by the pickup device into a digital signal. The signal processing device can, in general, be a Digital Signal Processor or an analog-to-digital converter (ADC). The video processing device may convert the digital signal output by the signal processing unit into the video data to be output on the display unit 350. The video processing device may deliver the video signal in a format appropriate for the display unit 350 under the control of one of the first and second control units 120 and 220.

The display unit 350 may display the video signal received from the camera unit 340 and/or from one of the first and second control units 120 and 220 as a screen image. The display unit 350 may also display menu screens, data input by the user, and/or operation status information. The display unit 350 can be implemented as a Liquid Crystal Display (LCD). If the LCD supports touch screen functions, the display unit 350 can operate as a part of the input unit 320.

As a characteristic of the standby mobile terminal, the first and second control unit 130 and 230 may share functions of the common module 300. Thus, one of the first and second control units 130 and 230 may operate as a master device controller (master control unit) and the other control unit may operate as a slave device controller (slave control unit). The master control unit may control the common module 300 directly, and the slave control unit can control the common module 300 under control of the master control unit. The master control unit can control the operations of the slave control unit.

For example, the first and second control units 130 and 230 may be configured to operate as master and slave control units respectively. The first control unit 120 may control the common module 300 directly. That is, the master control unit 120 may control overall operations of the dual standby mobile terminal and signaling among internal functions. In this case, the first control unit 120 may control functions of the mobile terminal in response to a signal (e.g., signal input generated by a touch event on a touch screen) input through the input unit 320 to display information such as operation status and a user menu on the display unit 350. The first control unit 120 may also storespecific data in the storage unit 330.

When a video call key is input, the first control unit 120 may instruct the first communication module 100 to perform a call connection process using the first RF unit 110 and, simultaneously, the second control unit 220 may instruct the second communication module 200 to perform a call connection process using the second RF unit 210. When the video call key is input, the first control unit 120 may process a call connection process using the first RF unit 110 and send the video call key to the second control unit 220 simultaneously.

Although not depicted in the drawing, the common module 300 of the mobile terminal may further include at least one of a broad reception unit, a charging port, and an MP3 playback unit. It should be understood that other components may be incorporated in the mobile terminal and that the aforementioned devices and their equivalents can be selectively integrated into the mobile terminal.

Once a pair of simultaneous call connections has been established with the counterpart mobile terminal, the mobile terminal can transmit and receive voice signals through the radio channel established by the first communication module 100 and video signals through the radio channel established by the second communication module 200.

To perform video communication in the manner disclosed herein, the counterpart mobile terminal should also support the dual standby mode and acquire the connection identifiers for parallel call connections. Information on acquiring capability and connection identifiers of the counterpart mobile terminal is described hereinafter.

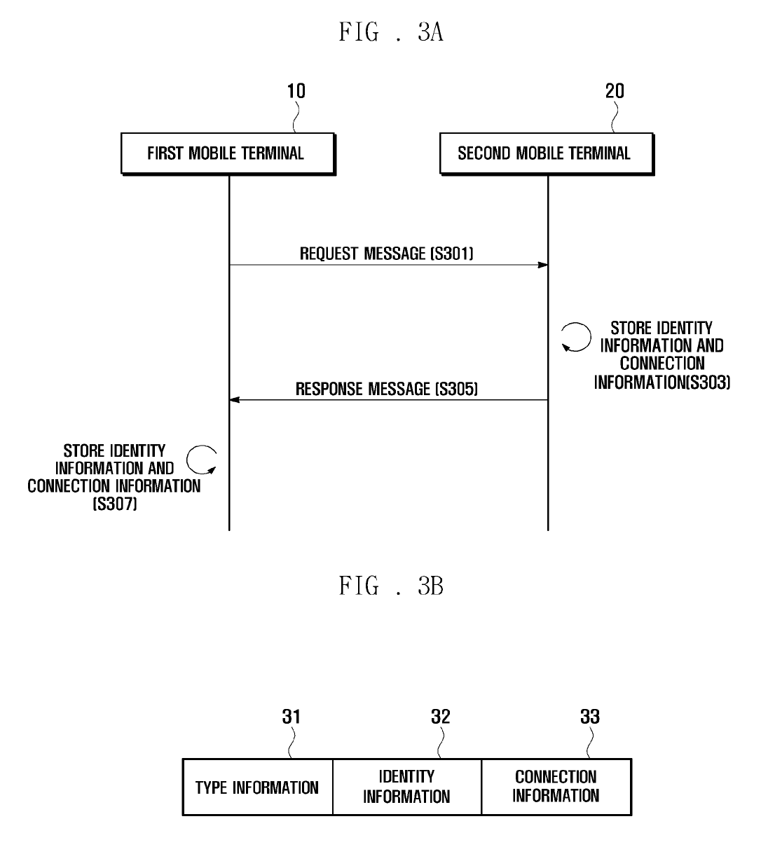

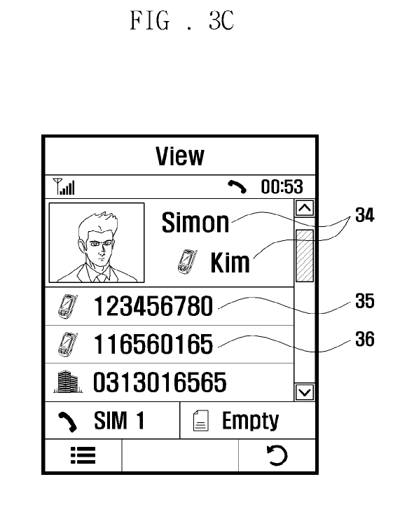

FIG. 3A, FIG. 3B, and FIG. 3C provide illustrations that may help explain the procedure for acquiring information related to the parallel call connections. FIG. 3A, FIG. 3B, and FIG. 3C, the first mobile terminal 10 may be the sending mobile terminal and the second mobile terminal 20 may be the recipient mobile terminal. However, in other cases, the second mobile terminal 20 may be transmitting and the first mobile terminal 10 may be receiving.

FIG. 3A is a message flow diagram illustrating a procedure for acquiring information for video communication according to exemplary embodiments of the present invention.

Referring to FIG. 3A, the first mobile terminal 10 may send a request message requesting the second mobile terminal 20 for identity information (S301). That is, the first mobile terminal 10 may request the second mobile terminal 20 to provide identity information of the second mobile terminal's first and second communication modules.

FIG. 3B is a diagram illustrating an example of the request message transmitted at step S301. As shown in FIG. 3B, the request message may include a type information field 31, an identity information field 32, and a connection information field 33. The type information field 31 may indicate that the type of message, for example, a request message. The identity information field 32 may indicate the device identifier of the first mobile terminal 10, and the connection information field 33 may indicate connection identifiers assigned to the first and second communication modules of the first mobile terminal 10. The identity information field 32 may include the device ID of the first mobile terminal 10 and/or a name of the first mobile terminal's owner. The connection information field 33 may include information (e.g., phone numbers assigned to the first and second communication modules of the first mobile terminal 10) for the respective communication modules to establish call connections. The identity information 32 and the connection information 33 may be stored in the USIM units 130 and 230 of the first mobile terminal 10. It should be understood that the request message may be provided in various other suitable formats and is not limited to the exemplary embodiments presented herein.

Upon receipt of the request message, the second mobile terminal 20 may store the identity information and connection information extracted from the request message (S303).

When a mobile terminal owner's name is used as the identity information, the second mobile terminal 20 may search its phonebook for the owner's name and may display the owner's information (i.e., the caller's information) as the search result, as shown in FIG. 3C. The caller's information may include the caller's name 34 and phone numbers 35 and 36 assigned to the first and second modules of the first mobile terminal 10.

Next, the second mobile terminal 20 may send a response message to the first mobile terminal 10 in response to the request message (S305). The response message may have a similar format as the one shown in FIG. 3B. That is, the response message may include a type information field 31 for indicating that the message is a response message, an identity information field 32 indicating the device identifier of the second mobile terminal 20, and a connection information field 33 for indicating connection identifiers assigned to the first and second communication modules of the second mobile terminal 20. The identity information field 32 may include the device ID of the second mobile terminal 20 or the name of the second mobile terminal's owner. The connection information field 33 may include information (e.g., phone numbers assigned to the first and second communication modules of the second mobile terminal 20) required for the communication modules of the second mobile terminals to establish call connections. The identity information and the connection information may be stored in the corresponding USIM units of the second mobile terminal 20. It should be understood that the response message may be provided in various other suitable formats and is not limited to the exemplary embodiments presented herein.

Upon receipt of the response message, the first mobile terminal 10 may store the identity information and connection information extracted from the response message (S307). As noted above, the identity information and connection information may be stored in the storage unit 330, the first USIM unit 130, and/or the second USIM unit 230 together with mapping information between the identity information and the connection information.

Once the identity and connection information of the second mobile terminal 20 is acquired, the identity and connection information can be presented as shown in FIG. 3C as a result of a phonebook search with the owner's name of the second mobile terminal 20. The search result may show the phone numbers 34 and 36 of the first and second communication modules of the second mobile terminal 20 together with the owner's name.

In some exemplary embodiments, the mobile terminal can acquire the connections information related to the individual communication modules of the counterpart mobile terminal by exchanging control messages with the counterpart mobile terminal. The mobile terminal may acquire and store connection information of more than two communication modules of the counterpart mobile terminal. Phone numbers assigned to the communication modules of the counterpart mobile terminal can also be manually input by the user.

Once the mobile terminal has the identity information and connection information of the counterpart mobile terminal, a video communication method as described hereinafter may be utilized.

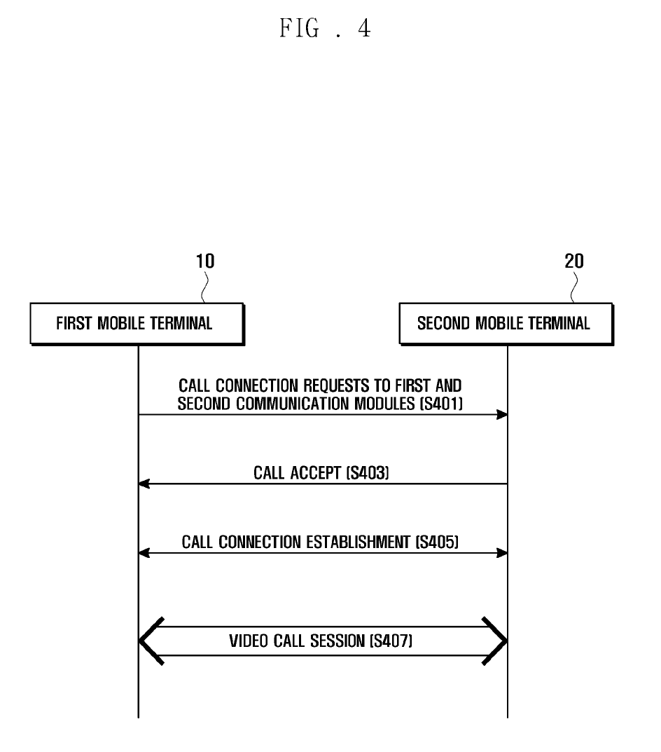

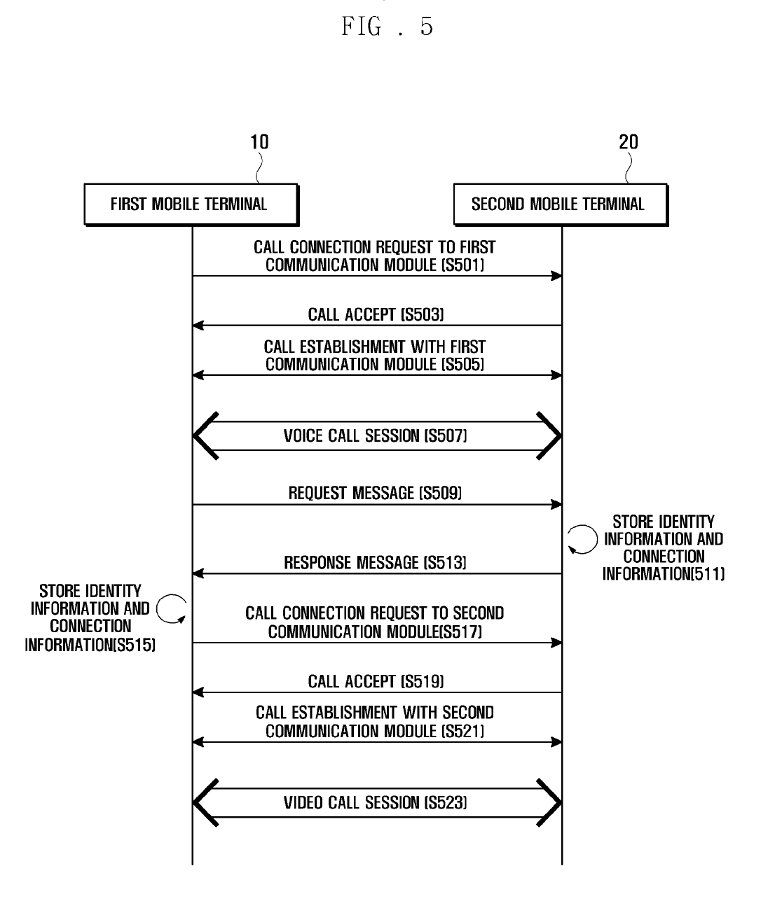

FIG. 4 is a message flow diagram illustrating a video communication method according to exemplary embodiments of the present invention.

In FIG. 4, the first mobile terminal 10 may, by way of example, be a sending mobile terminal, and the second mobile terminal 20 may be a recipient mobile terminal. The first control unit 120 may, by way of example, be a master control unit, and the second control unit 220 may be a slave control unit. The corresponding communication modules of the first and second mobile terminal 10 and 20 may operate with identical radio communication protocol in the same service provider's network. It should, however, be understood that other configurations are possible. For example, in other cases, the second mobile terminal 20 may be the sending mobile terminal and the second control unit 220 may be the master control unit.

Referring to FIG. 4, each mobile terminal may be provided with a video call key. The video call key may be a special key configured to implement video communication. A user of the first mobile terminal 10 may select the special key to make a video call to the second mobile terminal 20 after inputting the phone number assigned to one of the first and second communication modules of the second mobile terminal 20. Once the special key input is detected, the first mobile terminal 10 may activate its first and second communication modules 100 and 200 to simultaneously send call connection requests to the first and second communication modules of the second mobile terminal 20 (S401). At this time, the call connections may be implemented using the base stations of the service providers corresponding to the respective first and second communication modules 100 and 200. The message exchange and communication quality negotiation can be performed in various manners depending on the network configuration and radio communication protocols used by the service providers.

Upon receipt of the call connection requests through the first and second communication modules, the second mobile terminal 20 may recognize the video call request by referring to the previously stored identity information and connection information on the first mobile terminal 10. The second mobile terminal may check the identity and connection information of the two call connection request message received through its first and second communications modules and may process the call requests as a video call request since the identity information of the call connection request messages has been mapped to the connection information. The second mobile terminal may then display an announcement message notifying the user of the incoming video call. For example, the second mobile terminal 20 may display the identity information and connection information of the first mobile terminal 10 on its display unit 350. The identity information can be the owner's name of the first mobile terminal 10, and the connection information can be the phone numbers of the first and second communication modules of the first mobile terminal 1O.

During the call request process, the first mobile terminal 10 may play a ring-back tone. The second mobile terminal 20 may play a ring tone using its audio processing unit 310 and may display the identity and connection information of the first mobile terminal 10. The user of the second mobile terminal 20 can receive the video call by selecting a call accept key.

Once the user of the second mobile terminal 20 selects the call accept key, the second mobile terminal 20 sends a call accept message to the first mobile terminal 10 (S403) and establishes call connections with the first mobile terminal 10 (S405).

After a first call connection between the first communication modules and a second call connection between the second communication modules has been established, video communication between the first and second mobile terminals 10 and 20 may be enabled (S407).

As described above, the first module 100 of each mobile terminal may be responsible for processing voice signals, and the second module 200 of each mobile terminal may be responsible for processing video signals. In both mobile terminals 10 and 20, the first control unit 120 may instruct the audio processing unit 310 to process voice signals received through the first RF unit 110 and an audio output device (e.g., speaker) to output the voice signals in the form of an audible sound wave. In both mobile terminals 10 and 20, the first control unit 120 may also instruct the audio processing unit 310 to process an audio signal input through the audio input device (e.g., microphone) and to transmit the audio signal through the first RF unit 110. Simultaneously, in both mobile terminals, the second control unit 220 may instruct the display unit 350 to display a video signal received through the second RF unit 210. The second control unit 220 in both mobile terminals may also instruct the second RF unit 210 to transmit a video signal input through the camera unit 340.

The second control unit 220 and/or the first control unit 120 may convert the video signal to a format appropriate for the communication channel. For example, when the communication channel established between the second communication modules of the first and second mobile terminal is a voice communication channel, the second control unit 220 may downscale the video signal to be delivered through the voice connection channel.

According to some exemplary embodiments of the present invention, the video communication can be accomplished using the connection information of a single communication module. FIG. 5 is a message flow diagram illustrating a video communication method according to exemplary embodiments of the present invention. The first mobile terminal 10 may, by way of example, be a sending mobile terminal, and the second mobile terminal 20 may be a recipient mobile terminal. The corresponding communication modules of the first and second mobile terminals 10 and 20 may operate using the same radio communication protocol on the same service providers' networks. It should be understood that in other cases, the second mobile terminal 20 may be transmitting and the first mobile terminal 10 may be receiving and that different service providers may be used.

Referring back to FIG. 5, the first mobile terminal 10 may input the phone number of the second mobile terminal 20 and may make a voice call to the second mobile terminal 20 in response to a key input on a normal call button. If a voice call input is detected, the first mobile terminal 10 may send a call connection request message, using its first communication module 100, to the second mobile terminal 20 for establishing a call connection with the first communication module 100 of the second mobile terminal 20 (S501).

During the call connection request process, the first mobile terminal 10 may play a ring-back tone, and the second mobile terminal 20 may play a ring tone to notify the user of the incoming call.

If a call accept key is input by the user of the second mobile terminal 20, the second mobile terminal 20 may send a call accept message to the first mobile terminal (S503) and may establish a call connection with the first mobile terminal 10 (S505). After the call connection is established, voice communication between the first and second mobile terminals 10 and 20 may be enabled (S507).

To establish a video call connection, each mobile terminal should know the connection information of the first and second communication modules 100 and 200 of the counterpart mobile terminal. For this purpose, each mobile terminal can send a request message to the counterpart mobile terminal. In FIG. 5, the first mobile terminal 10 may send the request message to the second mobile terminal 20 during the voice call session (S509). Upon receipt of the request message, the second mobile terminal 20 may store the identity information and connection information extracted from the request message (S511). Next, the second mobile terminal 20 may send a response message to the first mobile terminal 10 in response to the request message (S513). Upon receipt of the response message, the first mobile terminal may store the identity information and connection information extracted from the response message (S515).

After storing the identity and connection information, the first mobile terminal 10 may send a video call connection request message to the second mobile terminal (S517). Upon receipt of the video call connection request message, the second mobile terminal 20 may send a video call accept message to the first mobile terminal (S519) and thus a video channel may be established between the second modules 200 of the first and second mobile terminals 10 and 20(S521).

In such cases, after the voice call connection is established between the first communication modules of the first and second mobile terminals 10 and 20, the video channel may be established between the second communication modules 200 of the first and second mobile terminals 10 and 20 (S523). As noted above, the first modules 100 of the first and second mobile terminals 10 and 20 may be responsible for processing the voice signals, and the second modules 200 of the first and second mobile terminals 10 and 20 may be responsible for processing the video signals.

In both mobile terminals 10 and 20, the first control unit 120 may instruct the audio processing unit 310 to process the voice signals received through the first RF unit 110 and an audio output device (e.g., speaker) to output the voice signals in the form of an audible sound wave. In both mobile terminals 10 and 20, the first control unit 120 may also instruct the audio processing unit 310 to process an audio signal input through the audio input device (e.g., microphone) and to transmit the audio signal through the first RF unit 110. Simultaneously, in both mobile terminals 10 and 20, the second control unit 220 may instruct the display unit 350 to display a video signal received through the second RF unit 210. The second control unit 220 in both mobile terminals 10 and 20 may also instruct the second RF unit 210 to transmit a video signal input through the camera unit 340.

As described above, the dual standby mobile terminal according to exemplary embodiments of the present invention may establish a voice channel using one of two communication modules and a video channel using another communication module, to communicate with a counterpart dual standby mobile terminal. Accordingly, exemplary embodiments provided herein accomplish video communication capability with dual standby function without additional video call related components, resulting in increased utility of the mobile terminal.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A video communication apparatus for a first multi-standby mobile terminal, comprising:
a first communication module to establish a voice channel with a counterpart second mobile terminal to exchange voice signals via a first communication network; and
a second communication module to establish a video channel with the second mobile terminal to exchange video signals via a second communication network.

2. The video communication apparatus of claim 1, wherein one of the first and second communication modules exchanges, with the second mobile terminal, device identity information and connection information mapped to the device identity information and stores the device identity information and connection information, and each of the first and second communication modules establishes the voice and video channels using the device identity information and the connection information.

3. The video communication apparatus of claim 1, wherein each of the first and second communication modules establishes a call connection with corresponding communication modules of the second mobile terminal using previously stored identity information and connection information.

4. The video communication apparatus of claim 1, wherein each of the first and second communication modules comprises:
a radio frequency (RF) unit to transmit and receive radio signals carrying a message and a voice signal or a video signal;
a Universal Subscriber Identity Module (USIM) unit to store identity information and connection information of at least one of the first and second communication modules of the second mobile terminal; and
a control unit to instruct the RF unit to transmit and receive the radio signals, to store the identity information and connection information of the second mobile terminal in the USIM unit, and to establish the voice and video channels with the second mobile terminal.

5. The video communication apparatus of claim 4, wherein the control unit controls the RF unit to transmit and receive the voice signals when the voice channel is established and the video signals when the video channel is established.

6. The video communication apparatus of claim 1, further comprises:
an audio processing unit to process audio signals received from and output to one of the communication modules;
a camera unit to provide video signals for transmitting to the second mobile terminal; and
a display unit to display video signals received from the second mobile terminal.

7. A video communication method for a first multi-standby mobile terminal having at least two communication modules supporting different communication systems, the method comprising:
establishing two communication channels with a counterpart second mobile terminal using the at least two communication modules; and
transmitting voice signals through a first communication channel and video signals through a second communication channel.

8. The video communication method of claim 7, wherein the communication channels are established using identity information and connection information mapped to the identity information, the connection information being assigned to the at least two communication modules of the mobile terminal and communication modules of the second mobile terminal.

9. The video communication method of claim 8, further comprising:
exchanging, between the first and second mobile terminals, the identity information and the connection information; and
storing the identity information and the connection information in the first and second mobile terminals.

10. A video communication method for a first multi-standby mobile terminal having at least two communication modules supporting different communication systems, the method comprising:
establishing a voice call connection, using a first communication module of the at least two communication modules, with a corresponding first communication module of a counterpart second mobile terminal;
exchanging, with the second mobile terminal, messages containing identity information and connection information;
establishing a video call connection, using a second communication module of the at least two communication modules, with a corresponding second communication module of the second mobile terminal; and
communicating voice signals through the voice call connection and video signals through the video call connection with the second mobile terminal.
